(19) United States
(12) Patent Application Publication
(10) Pub. No.: US 2013/0117749 A1
(43) Pub. Date: May 9, 2013

(54) Provisioning and Managing an Application Platform

(71) Applicants: Thomas A.J. Mechelke, Seattle, WA (US); Arshish Kapadia, Issaquah, WA (US); Saji Varkey, Redmond, WA (US); Ryan David Yandle, Seattle, WA (US); Peter Adam Outcalt, Redmond, WA (US); Chandan Aggarwal, Seattle, WA (US); Howard M. Crow, Sammamish, WA (US); Michael H. Ammerlaan, Sammamish, WA (US); Gersh Payzer, Seattle, WA (US); Shailesh Panwar, Seattle, WA (US)

(72) Inventors: Thomas A.J. Mechelke, Seattle, WA (US); Arshish Kapadia, Issaquah, WA (US); Saji Varkey, Redmond, WA (US); Ryan David Yandle, Seattle, WA (US); Peter Adam Outcalt, Redmond, WA (US); Chandan Aggarwal, Seattle, WA (US); Howard M. Crow, Sammamish, WA (US); Michael H. Ammerlaan, Sammamish, WA (US); Gersh Payzer, Seattle, WA (US); Shailesh Panwar, Seattle, WA (US)

(73) Assignee: Microsoft Corporation, Redmond, WA (US)

(21) Appl. No.: 13/288,175

(22) Filed: Nov. 3, 2011

(51) Int. Cl. G06F 9/46

(52) U.S. Cl. 718/102

(57) ABSTRACT

Platform management may be provided. First, a package may be received. The received package may then be separated into a plurality of deployment groups. Next, a plurality of tasks may be created for deploying the plurality of deployment groups. Then the plurality of tasks may be executed.

### BACKGROUND

Cloud computing provides computation, software, data access, and storage services that do not require end-user knowledge of the physical location and configuration of the system that delivers the services. Parallels to this concept can be drawn with the electricity grid, wherein end-users consume power without needing to understand the component devices or infrastructure required to provide the service.

Cloud computing describes a new supplement, consumption, and delivery model for IT services based on Internet protocols, and it typically involves provisioning of dynamically scalable and often virtualized resources. It is a byproduct and consequence of the ease-of-access to remote computing sites provided by the Internet. This may take the form of web-based tools or applications that users can access and use through a web browser as if the programs were installed locally on their own computers.

### SUMMARY

This Summary is provided to introduce a selection of concepts in a simplified form that are further described below in the Detailed Description. This Summary is not intended to identify key features or essential features of the claimed subject matter. Nor is this Summary intended to be used to limit the claimed subject matter's scope.

Platform management may be provided. First, a package may be received. The received package may then be separated into a plurality of deployment groups. Next, a plurality of tasks may be created for deploying the plurality of deployment groups. Then the plurality of tasks may be executed.

Both the foregoing general description and the following detailed description provide examples and are explanatory only. Accordingly, the foregoing general description and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF THE DRAWINGS

The accompanying drawings, which are incorporated in and constitute a part of this disclosure, illustrate various embodiments of the present invention. In the drawings:

FIG. 1 is a block diagram of a cloud computing operating environment;

FIG. 2 is a flow chart of a method for providing platform management;

FIG. 3 is a diagram illustrating a package;

FIG. 4 is a diagram illustrating deployment groups; and

FIG. 5 is a block diagram of a system including a computing device.

### DETAILED DESCRIPTION

The following detailed description refers to the accompanying drawings. Wherever possible, the same reference numbers are used in the drawings and the following description to refer to the same or similar elements. While embodiments of the invention may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the invention. Instead, the proper scope of the invention is defined by the appended claims.

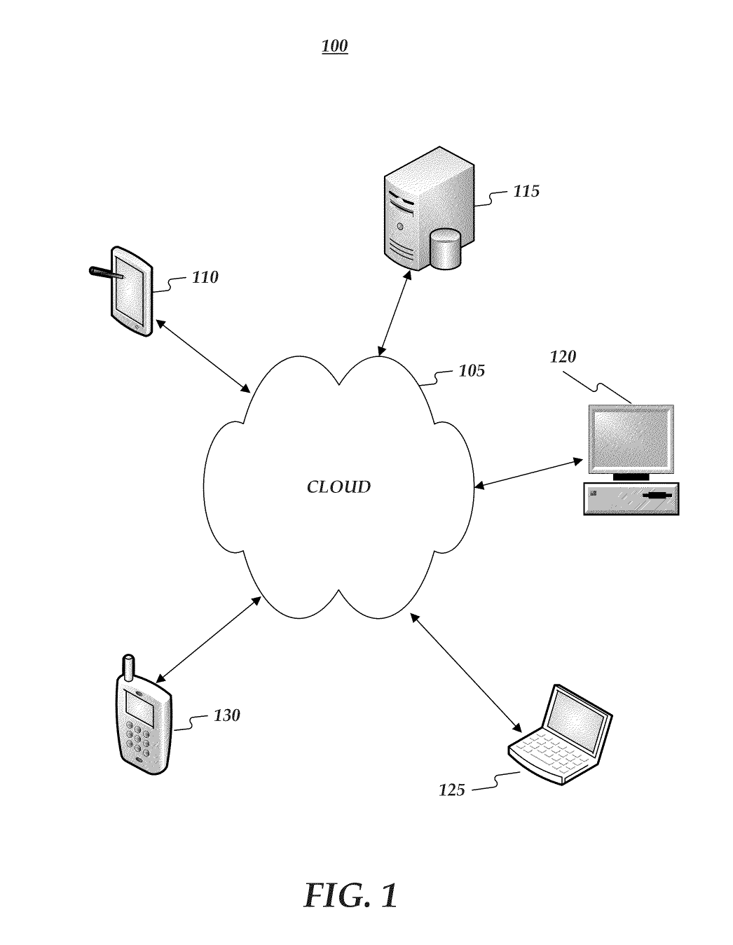

FIG. 1 is a block diagram of a cloud computing operating environment 100. As shown in FIG. 1, operating environment 100 may include a cloud 105 and a plurality of computing devices. Cloud 105 may include, for example, data centers having infrastructure, application platforms, and applications that may be used for cloud computing. Cloud computing may comprise the delivery of computing as a service rather than a product. In cloud computing, shared resources, software, and information may be provided to a plurality of computing devices connected to cloud 105 as a utility (e.g. like an electricity grid) over a network such as, but not limited to, the internet. For example, the plurality of computing devices may comprise, but are not limited to, a tablet device 110, a server 115, a desktop computer 120, a laptop computer 125, and a smart phone 130.

An application platform (e.g. The Windows® Azure® platform) in cloud 105 may allow datacenters to host and run applications. The application platform may serve as a runtime for applications and may provide a collection of services that may allow development, management, and hosting of applications off-premises for end users of the plurality of computing devices. Most of the applications may use more than one of these services to function. Also, components deployed to these services may need to be able to communicate and versioned as a unit. Conventional systems may not guarantee consistency across all services for a given application. Consequently, embodiments of the invention may provide a system that may provide distributed, resilient, and transactional deployment, upgrade and removal of applications across the application platform's services.

Embodiments of the invention may provide a packaging format, a set of lifecycle application program interfaces (APIs), a data store for storing deployment metadata, and application packages. In addition, embodiments of the invention may provide a set of components called deployment groups that may implement lifecycle operations for specific targets.

The packaging format may describe the application to be deployed at a high level as well its components and their relationships to each other. In a first phase of a deployment process, for each component in the package, an appropriate set of containers may be provisioned by a deployment group through APIs that may be specific to a deployment target (e.g. a database provisioned through SQL management interfaces). Subsequently, application components may be deployed to the containers. If all deployment steps were successful in the first phase, a second phase may configure any connections between the components.

The aforementioned process may be resilient to data center server crashes, connectivity issues, or errors in individual component deployments. For example, if a component deployment fails, it may be rolled back and retried. If retries are exhausted, then the whole app deployment may be rolled back. If server crashes or network connectivity is restored, a scheduled deployment job may pick up where previous processing left off. This is because the state of a deployment may be persisted in the store. An engine executing the deployment may make intelligent decisions about which components to rollback, retry, or install for the first time. Accordingly, embodiments of the invention may provide full multi-tier application deployments by the end users without system administration intervention.

Moreover, the engine executing the deployment may also support upgrading applications in a reliable way. This upgrade process may make a copy of a database, if it exists, and the site including the data stored in lists and document libraries. The copies may then be upgraded in place. If the upgrade process fails, the upgrade process may fall back to the original application instance.

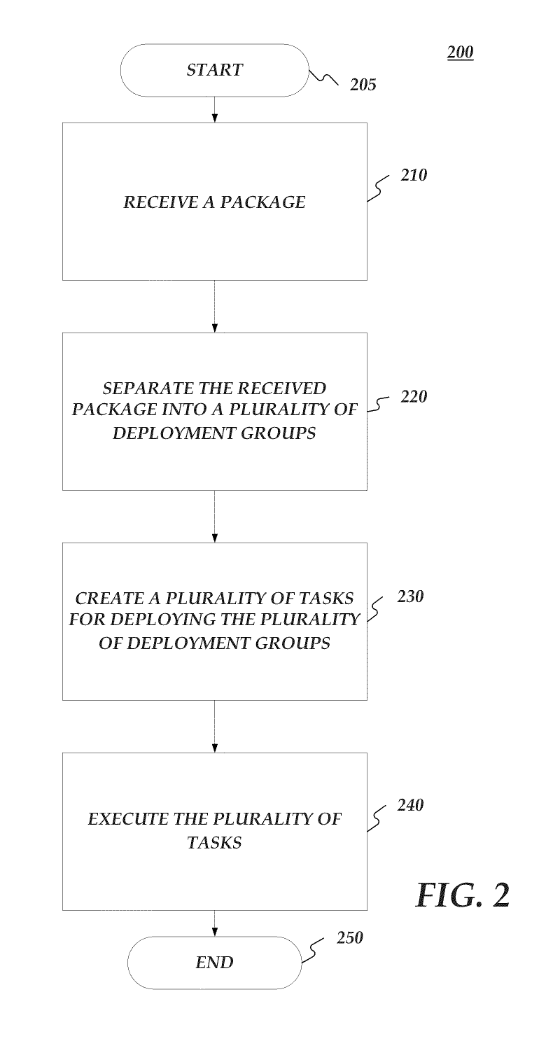

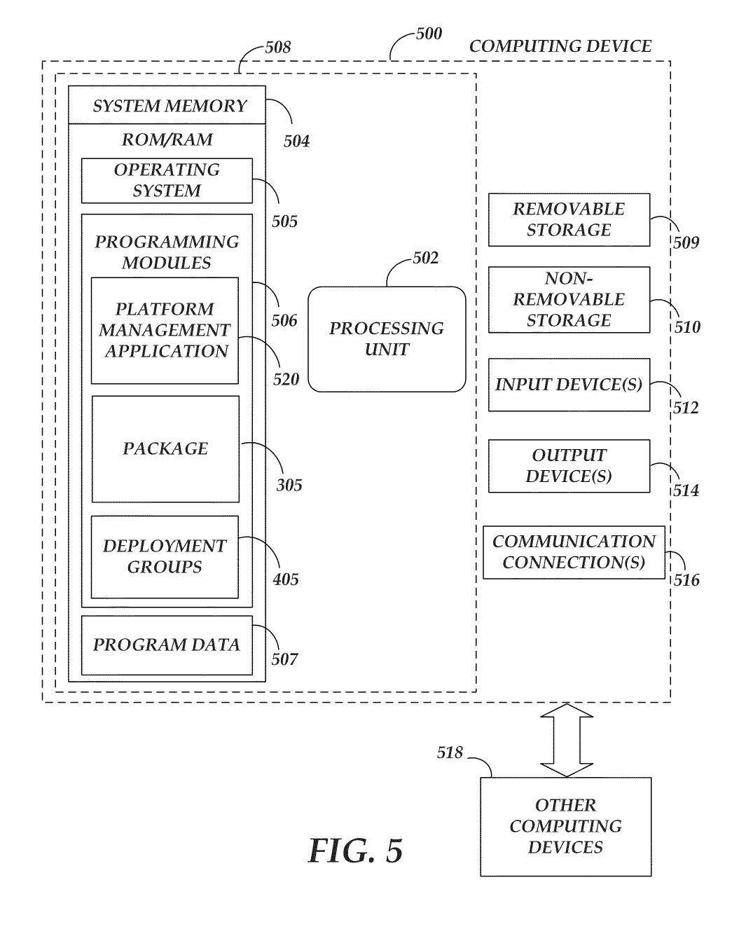

FIG. 2 is a flow chart setting forth the general stages involved in a method 200 consistent with an embodiment of the invention for providing platform management. Method 200 may be implemented using a computing device 500 as described in more detail below with respect to FIG. 5. Ways to implement the stages of method 200 will be described in greater detail below.

Method 200 may begin at starting block 205 and proceed to stage 210 where computing device 500 may receive a package 305. For example, a developer may wish to create an application (e.g. an interview management application) that may have three components. A first component may comprise a database that stores data about interviewees and how the interviews go. A second component may comprise code that the developer may write to processes the data and create reports. A third component may comprise a visual layer that may display the data and reports and interact with users (e.g. over the internet). The aforementioned interview management application is an example and any type of application may be used.

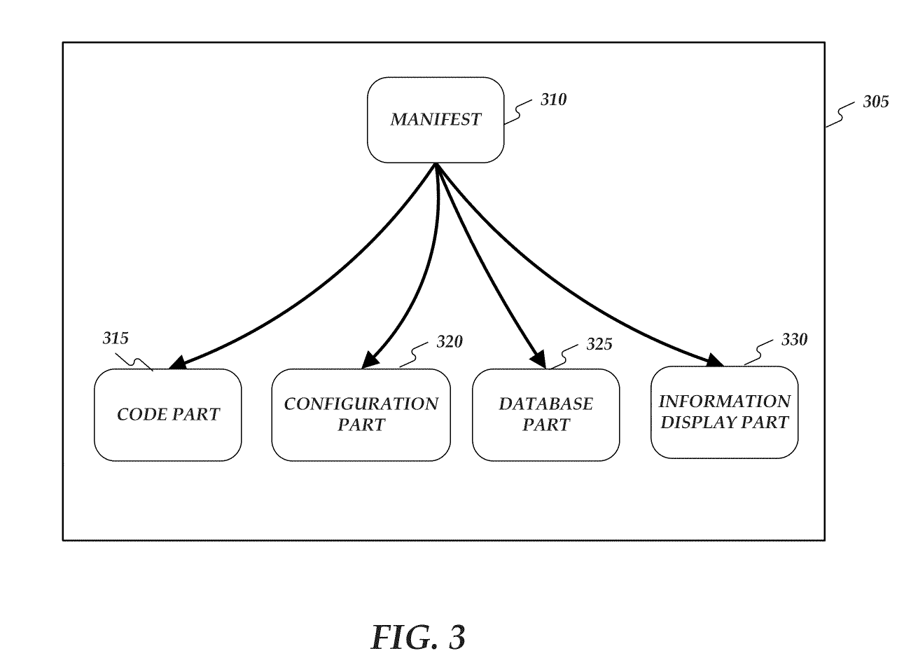

In writing the aforementioned interview management application, the developer may aggregate the three components into package 305. Accordingly, package 305 may comprise a plurality of parts corresponding to the aforementioned components. For example, the plurality of parts may comprise, but are not limited to, a first part 315 corresponding to the aforementioned code component (e.g. an ASP.Net web application), a second part 320 corresponding to configuration of the interview management application, a third part 325 corresponding to the aforementioned database component (e.g. SQL DDL scripts that define the schema of the database that the application needs), and a fourth part 330 corresponding to the aforementioned visual layer (e.g. information display UR layer) component. Furthermore, package 305 may include a manifest 310 that may define a structure of package 305 and relationships between the plurality of parts. After the developer aggregates the three components into package 305 as illustrated in FIG. 3, the developer may pass package 305 to computing device 500 that may receive package 305.

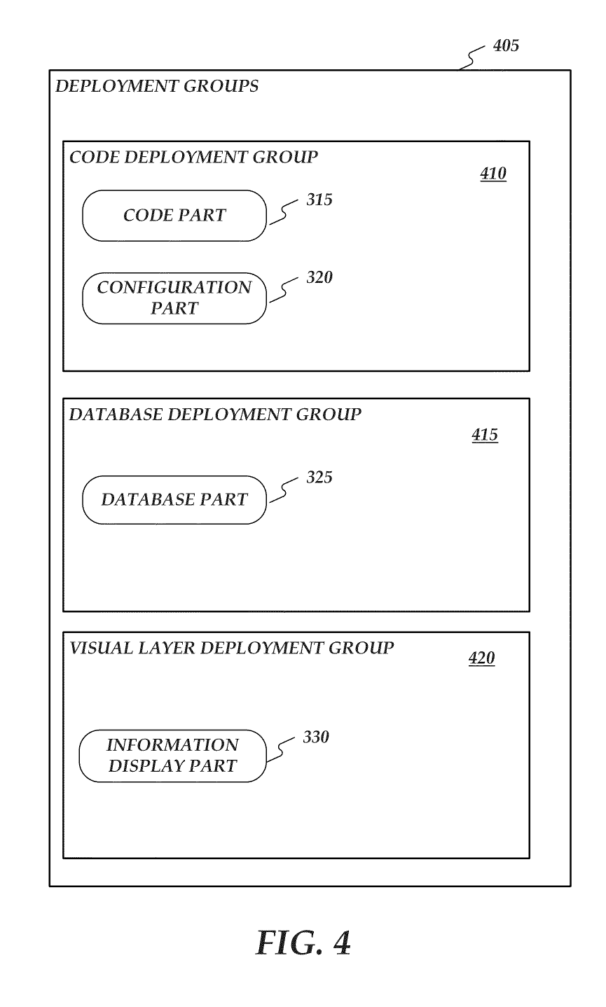

From stage 210, where computing device 500 receives package 305, method 200 may advance to stage 220 where computing device 500 may separate received package 305 into a plurality of deployment groups 405 as illustrated in FIG. 4. For example, plurality of deployment groups 405 may comprise, but are not limited to, a code deployment group 410, a database deployment group 415, and a visual layer (e.g. application web development) deployment group 420. Computing device 500 may separate received package 305 into plurality of deployment groups 405 based upon information contained in manifest 310 contained in received package 305.

Consistent with embodiments of the invention, computing device 500 may open received package 305, examine its contents, and separate the plurality of parts into plurality of deployment groups 405. For example, computing device 500 may separate first part 315 corresponding to the aforementioned code component and second part 320 corresponding to configuration of the interview management application into code deployment group 410. In addition, computing device 500 may separate database part 325 into database deployment group 415. Furthermore, computing device 500 may separate information display part 330 into visual layer deployment group 420.

Embodiments of the invention may have more or less that the above mentioned three deployment groups 405. For example, it is possible that the interview management application may not include a database and/or a visual layer. Consequently, the plurality of parts may not respectively include third part 325 corresponding to the aforementioned database component and/or fourth part 330 corresponding to the aforementioned visual layer component. Accordingly, plurality of deployment groups 405 may not respectively include database development group 415 and/or visual layer development group 420.

Once computing device 500 separates the received package into the plurality of deployment groups in stage 220, method 200 may continue to stage 230 where computing device 500 may create a plurality of tasks for deploying plurality of deployment groups 405. For example, computing device 500 may create a series of tasks (e.g. a job) and save them to a content database. In order to determine what tasks to include in the content database, computing device 500 may analyze plurality of deployment groups 405 and determine what different tasks to include. In other words, the content database includes a series of tasks queued. These tasks may have dependencies between one another where the queue may be ordered so as to execute tasks that may need to go first before any subsequent tasks. For example, a task may execute a “fix-up” stage that may cause ones of the plurality of these deployment groups 405 to exchange information such as a database connection string.

After computing device 500 creates the plurality of tasks for deploying the plurality of deployment groups in stage 230, method 200 may proceed to stage 240 where computing device 500 may execute the plurality of tasks. For example, a timer process may run on computing device 500. The timer process may periodically check the content database for new tasks. When the timer process sees new tasks in the content database, the timer process may pull one task out at a time, executes it, and when successfully executed, the time process writes back to the content database that the task was finished. In this way, the status of tasks and their progress is persisted in a durable store.

When executing tasks, a number of failure issues may arise. For example, computing device 500 may go down during execution of the new tasks in the content database, but before all the new tasks in the content database are completed. However, the next time the job containing the tasks runs after computing device 500 is back up, since all the task definitions may be persisted to the content database, the job may pick up and resume from where it left off.

Another failure may arise due to network issues in cloud 105 that may cause deployment group implementation to stop responding to computing device 500. Consequently, embodiments of the invention may include a “rollback” feature. With the rollback feature, if one of the tasks in the job does not report back as successfully executed, then all the previous tasks in the job may be undone (i.e. rolled back.) If any of the undoing of the previous tasks does not report back as successfully executed, then the unsuccessful undo will be repeated until it is successful. Once all tasks are undone, computing device 500 may try to re-execute the tasks until all the tasks are successfully completed.

Embodiments of the invention may also include an update feature. For example, a first version of package 305 may be successfully deployed. Then, the developer may write a new, updated (e.g. second) version of package 305 and may want it to be deployed in place of the former, first version of package 305. In this case, manifest 310 of the second version of package 305 may indicate that it is a “Version 2.” Consequently, computing device 500 may compare the first version of package 305 to the second version of package 305 to determine what is different and then carry out a deployment (create and execute tasks) to replace the differences. For example, the second version may have a different database part that the first version. Consequently, the second version database part may be deployed in the place of the first version database part. Or the second version may not even use a database at all. In this case, the database part of the first version may be removed. Furthermore, the second version may have a different code part that the first version. Consequently, the second version code part may be compared to the already deployed the first version code part. Accordingly, the difference between the two code parts may be deployed. Information display part 330 in the first version may be completely different in the second version, so display part 330 may be completely replace in the second version deployment. Also, package 305 for the second version may have parts not corresponding to any parts of package 305 for the first version. In this case, parts in package 305 for the second version not corresponding to any parts of package 305 for the first version may be deployed.

Further regarding the update feature, if the update process identifies that a component is present in both the old and the new version, it may update the component in a manner that avoids the possibility of data loss and may maintain end user access to the application while the update is being carried out. This may be achieved by the deployment group contract for a computation container affording the following characteristics: i) a way by which a component may be backed up; ii) a way by which the backed up component may be updated; iii) a way by which the current component and the updated, backed up component may be switched from an end user's perspective, quickly; and iv) a way by which all component switches can be synchronized such that any application availability loss perceived by the user is minimized.

In sum, a developer may create package 305 with a number of different parts. The developer may send package 305 to computing device 500 that may analyzes package 305 and create deployment groups 405. Computing device 500 may then analyze deployment groups 405 and write all of the tasks that are needed into the content database. A timer service may then pick up the tasks and execute the tasks based on their dependencies thus deploying package 305. Once computing device 500 executes the plurality of tasks in stage 240, method 200 may then end at stage 250.

An embodiment consistent with the invention may comprise a system for providing platform management. The system may comprise a memory storage and a processing unit coupled to the memory storage. The processing unit may be operative to receive a package and separate the received package into a plurality of deployment groups. In addition, the processing unit may be operative to create a plurality of tasks for deploying the plurality of deployment groups and to execute the plurality of tasks.

Another embodiment consistent with the invention may comprise a system for providing platform management. The system may comprise a memory storage and a processing unit coupled to the memory storage. The processing unit may be operative to separate a package into a plurality of deployment groups and to create a plurality of tasks for deploying the plurality of deployment groups. Furthermore, the processing unit may be operative to execute a first portion of the plurality of tasks, to undo the executed first portion of the plurality of tasks, and to execute the plurality of tasks.

Yet another embodiment consistent with the invention may comprise a system for providing platform management. The system may comprise a memory storage and a processing unit coupled to the memory storage. The processing unit may be operative to receive a first package corresponding to a first version of software, separate the received first package into a first plurality of deployment groups, and to create a first plurality of tasks for deploying the first plurality of deployment groups. Furthermore, the processing unit may be operative to execute the first plurality of tasks, receive a second package corresponding to a second version of the software, and to undo, in response to receiving the second package corresponding to the second version of the software, the deployment of the first plurality of deployment groups. Moreover, the processing unit may be operative to separate the received second package into a second plurality of deployment groups, create a second plurality of tasks for deploying the second plurality of deployment groups, and to execute the second plurality of tasks.

FIG. 5 is a block diagram of a system including computing device 500. Consistent with an embodiment of the invention, the aforementioned memory storage and processing unit may be implemented in a computing device, such as computing device 500 of FIG. 5. Any suitable combination of hardware, software, or firmware may be used to implement the memory storage and processing unit. For example, the memory storage and processing unit may be implemented with computing device 500 or any of other computing devices 518, in combination with computing device 500. The aforementioned system, device, and processors are examples and other systems, devices, and processors may comprise the aforementioned memory storage and processing unit, consistent with embodiments of the invention. Furthermore, computing device 500 may comprise an operating environment for any of the plurality of computing devices (e.g. tablet device 110, server 115, desktop computer 120, laptop computer 125, and smart phone 130) as described above. Any of the plurality of computing devices may operate in other environments and are not limited to computing device 500.

With reference to FIG. 5, a system consistent with an embodiment of the invention may include a computing device, such as computing device 500. In a basic configuration, computing device 500 may include at least one processing unit 502 and a system memory 504. Depending on the configuration and type of computing device, system memory 504 may comprise, but is not limited to, volatile (e.g. random access memory (RAM)), non-volatile (e.g. read-only memory (ROM)), flash memory, or any combination. System memory 504 may include operating system 505, one or more programming modules 506, and may include a program data 507. Operating system 505, for example, may be suitable for controlling computing device 500's operation. In one embodiment, programming modules 506 may include, for example, a platform management application 520. Furthermore, embodiments of the invention may be practiced in conjunction with a graphics library, other operating systems, or any other application program and is not limited to any particular application or system. This basic configuration is illustrated in FIG. 5 by those components within a dashed line 508.

Computing device 500 may have additional features or functionality. For example, computing device 500 may also include additional data storage devices (removable and/or non-removable) such as, for example, magnetic disks, optical disks, or tape. Such additional storage is illustrated in FIG. 5 by a removable storage 509 and a non-removable storage 510. Computing device 500 may also contain a communication connection 516 that may allow computing device 500 to communicate with other computing devices 518, such as over a network in a distributed computing environment, for example, an intranet or the Internet. Communication connection 516 is one example of communication media.

The term computer readable media as used herein may include computer storage media. Computer storage media may include volatile and nonvolatile, removable and non-removable media implemented in any method or technology for storage of information, such as computer readable instructions, data structures, program modules, or other data. System memory 504, removable storage 509, and non-removable storage 510 are all computer storage media examples (i.e., memory storage). Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 500. Any such computer storage media may be part of device 500. Computing device 500 may also have input device(s) 512 such as a keyboard, a mouse, a pen, a sound input device, a touch input device, etc. Output device(s) 514 such as a display, speakers, a printer, etc. may also be included. The aforementioned devices are examples and others may be used.

The term computer readable media as used herein may also include communication media. Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

As stated above, a number of program modules and data files may be stored in system memory 504, including operating system 505. While executing on processing unit 502, programming modules 506 (e.g. platform management application 520) may perform processes including, for example, one or more method 200's stages as described above. The aforementioned process is an example, and processing unit 502 may perform other processes. Other programming modules that may be used in accordance with embodiments of the present invention may include electronic mail and contacts applications, word processing applications, spreadsheet applications, database applications, slide presentation applications, drawing or computer-aided application programs, etc.

Embodiments of the invention may be practiced via a system-on-a-chip (SOC) where each or many of the components illustrated in FIG. 5 may be integrated onto a single integrated circuit. Such an SOC device may include one or more processing units, graphics units, communications units, system virtualization units and various application functionality all of which may be integrated (or “burned”) onto the chip substrate as a single integrated circuit. When operating via an SOC, the functionality described herein with respect to embodiments of the invention, may be performed via application-specific logic integrated with other components of computing device 500 on the single integrated circuit (chip).

Computing device 500 may be coupled to a camera that may be operative to record a user and capture motions and/or gestures made by the user. Computing device 500 may be further operative to capture words spoken by the user, such as by a microphone, and/or capture other inputs from the user such as by a keyboard and/or mouse (not pictured). Consistent with embodiments of the invention, the camera may comprise any motion detection device capable of detecting the movement of the user. For example, the camera may comprise a Microsoft® Kinect® motion capture device comprising a plurality of cameras and a plurality of microphones.

Generally, consistent with embodiments of the invention, program modules may include routines, programs, components, data structures, and other types of structures that may perform particular tasks or that may implement particular abstract data types. Moreover, embodiments of the invention may be practiced with other computer system configurations, including hand-held devices, multiprocessor systems, microprocessor-based or programmable consumer electronics, minicomputers, mainframe computers, and the like. Embodiments of the invention may also be practiced in distributed computing environments where tasks are performed by remote processing devices that are linked through a communications network. In a distributed computing environment, program modules may be located in both local and remote memory storage devices.

Furthermore, embodiments of the invention may be practiced in an electrical circuit comprising discrete electronic elements, packaged or integrated electronic chips containing logic gates, a circuit utilizing a microprocessor, or on a single chip containing electronic elements or microprocessors. Embodiments of the invention may also be practiced using other technologies capable of performing logical operations such as, for example, AND, OR, and NOT, including but not limited to mechanical, optical, fluidic, and quantum technologies. In addition, embodiments of the invention may be practiced within a general purpose computer or in any other circuits or systems.

Embodiments of the invention, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present invention may be embodied in hardware and/or in software (including firmware, resident software, micro-code, etc.). In other words, embodiments of the present invention may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present invention, for example, are described above with reference to block diagrams and/or operational illustrations of methods, systems, and computer program products according to embodiments of the invention. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the invention have been described, other embodiments may exist. Furthermore, although embodiments of the present invention have been described as being associated with data stored in memory and other storage mediums, data can also be stored on or read from other types of computer-readable media, such as secondary storage devices, like hard disks, floppy disks, or a CD-ROM, a carrier wave from the Internet, or other forms of RAM or ROM. Further, the disclosed methods' stages may be modified in any manner, including by reordering stages and/or inserting or deleting stages, without departing from the invention.

All rights including copyrights in the code included herein are vested in and the property of the Applicant. The Applicant retains and reserves all rights in the code included herein, and grants permission to reproduce the material only in connection with reproduction of the granted patent and for no other purpose.

While the specification includes examples, the invention's scope is indicated by the following claims. Furthermore, while the specification has been described in language specific to structural features and/or methodological acts, the claims are not limited to the features or acts described above. Rather, the specific features and acts described above are disclosed as example for embodiments of the invention.

What is claimed is:

1. A method for providing platform management, the method comprising:
receiving a package;
separating the received package into a plurality of deployment groups;
creating a plurality of tasks for deploying the plurality of deployment groups; and
executing the plurality of tasks.

2. The method of claim 1, wherein receiving the package comprises receiving the package containing a plurality of parts.

3. The method of claim 1, wherein receiving the package comprises receiving the package containing a plurality of parts, wherein ones of the plurality of parts respectively comprise ones of the following: a first part corresponding to code, a second part corresponding to configuration, a third part corresponding to database format, and a fourth part corresponding to information display.

4. The method of claim 1, wherein receiving the package comprises receiving the package containing a manifest and a plurality of parts.

5. The method of claim 1, wherein receiving the package comprises receiving the package containing a manifest and a plurality of parts, the manifest defining a structure of the package and relationships between the plurality of parts.

6. The method of claim 1, wherein separating the received package into the plurality of deployment groups comprises separating the received package into the plurality of deployment groups, wherein ones of the plurality of deployment groups respectively comprise ones of the following: a database deployment group, a code deployment group, and a visual layer deployment group.

7. The method of claim 1, wherein separating the received package into the plurality of deployment groups comprises separating the received package into the plurality of deployment groups based upon a manifest contained in the received package.

8. The method of claim 1, wherein separating the received package into the plurality of deployment groups comprises separating the received package into the plurality of deployment groups based upon a manifest contained in the received package, the manifest defining a structure of the package and relationships between a plurality of parts in the received package.

9. The method of claim 1, wherein creating the plurality of tasks for deploying the plurality of deployment groups comprises:
analyzing the plurality of deployment groups;
determining the plurality of tasks; and
queuing the determined plurality of tasks in a content database in an order based upon dependences between the determined plurality of tasks.

10. The method of claim 1, wherein executing the plurality of tasks comprises:
periodically checking a content database for the plurality of tasks;
performing the plurality of tasks when the periodic check shows the plurality of tasks in the content database; and
writing back to the content database after the plurality of tasks have been performed.

11. The method of claim 1, wherein executing the plurality of tasks comprises:
performing a first portion the plurality of tasks;
stopping execution of the plurality of tasks when an engine executing the plurality of tasks fails; and
performing a second portion the plurality of tasks when the engine executing the plurality of tasks resumes.

12. A computer-readable medium that stores a set of instructions which when executed perform a method for providing platform management, the method executed by the set of instructions comprising:
separating a package into a plurality of deployment groups;
creating a plurality of tasks for deploying the plurality of deployment groups;
executing a first portion of the plurality of tasks;
undoing the executed first portion of the plurality of tasks; and
executing the plurality of tasks.

13. The computer-readable medium of claim 12, wherein undoing the executed first portion of the plurality of tasks comprises undoing the executed first portion of the plurality of tasks in response to determining that there is no response to executing a next task in the plurality of tasks after the first portion.

14. The computer-readable medium of claim 12, further comprising receiving the package.

15. The computer-readable medium of claim 14, wherein receiving the package comprises receiving the package containing a plurality of parts.

16. The computer-readable medium of claim 14, wherein receiving the package comprises receiving the package containing a plurality of parts, wherein ones of the plurality of parts respectively comprise ones of the following: a first part corresponding to code, a second part corresponding to configuration, a third part corresponding to database format, and a fourth part corresponding to information display.

17. The computer-readable medium of claim 14, wherein receiving the package comprises receiving the package containing a manifest and a plurality of parts.

18. The computer-readable medium of claim 14, wherein receiving the package comprises receiving the package containing a manifest and a plurality of parts, the manifest defining a structure of the package and relationships between the plurality of parts.

19. The computer-readable medium of claim 14, wherein separating the received package into the plurality of deployment groups comprises separating the received package into the plurality of deployment groups, wherein ones of the plurality of deployment groups respectively comprise ones of the following: a database deployment group, a code deployment group, and a visual layer deployment group.

20. A system for providing platform management, the system comprising:
a memory storage; and
a processing unit coupled to the memory storage, wherein the processing unit is operative to:
receive a first package corresponding to a first version of software;
separate the received first package into a first plurality of deployment groups;
create a first plurality of tasks for deploying the first plurality of deployment groups;
execute the first plurality of tasks;
receive a second package corresponding to a second version of the software;
undo, in response to receiving the second package corresponding to the second version of the software, the deployment of the first plurality of deployment groups;
separate the received second package into a second plurality of deployment groups;
create a second plurality of tasks for deploying the second plurality of deployment groups; and
execute the second plurality of tasks.
